(19) United States
(12) Patent Application Publication
(10) Pub. No.: US 2008/0013553 A1
(43) Pub. Date: Jan. 17, 2008

(54) ACTIVATION OF MULTIPLE BEARER SERVICES IN A LONG TERM EVOLUTION SYSTEM

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/755,850

(22) Filed: May 31, 2007

Related U.S. Application Data
(60) Provisional application No. 60/830,194, filed on Jul. 12, 2006.

(51) Int. Cl. H04L 12/66

(52) U.S. Cl. 370/401

(57) ABSTRACT

The present invention is related to a method of activating multiple bearer services in a long term evolution (LTE) wireless communication system including multiple bearers. At least one of the multiple bearers is activated during initial attach procedures which combine an attach procedure with activate packet data protocol (PDP) context activation procedures. In one embodiment, LTE attach procedures are implemented for multi-bearer services activation that establishes an LTE direct general packet radio service (GPRS) tunneling protocol (GTP) tunnel or normal GTP two-tunnels operation. In another embodiment, the initial attach procedures are used to activate a default PDP context to be followed by modified PDP context activation procedures for multi-bearer services activation. These procedures can be used to establish a modified LTE direct GTP tunnel or a normal GTP two-tunnels operation.

### CROSS REFERENCE TO RELATED APPLICATIONS

This application claims the benefit of U.S. Provisional Application No. 60/830,194 filed Jul. 12, 2006, which is incorporated by reference as if fully set forth.

### FIELD OF INVENTION

The present invention is related to a wireless communication system. More particularly, the present invention is related to the simultaneous activation of multiple bearer services upon attachment based on pre-configuration data stored in the WTRU in a long term evolution (LTE) general packet radio service (GPRS) tunneling protocol (GTP)-based system.

### BACKGROUND

FIG. 1 shows a conventional GPRS/third generation (3G) wireless communication system architecture 100 that shows various interfaces/protocols as well as user data transfer interfaces between various network entities. The wireless communication system 100 includes at least one serving GPRS support node (SGSN) 105 and at least one gateway GPRS support node (GGSN) 110. The wireless communication system 100 further comprises a universal terrestrial radio access network (UTRAN) 115 which includes one or more radio access networks (RANs), base station systems (BSSs) and radio network controllers (RNCs), (not shown). The system 100 also comprises a plurality of wireless transmit/receive units (WTRUs) 120, each including a terminal equipment (TE) 125 coupled to a mobile terminal (MT) 130. The mobility in the wireless communication system 100 is facilitated by anchoring an Internet Protocol (IP) session at the GGSN 110 and allowing for multi-level mobility by supporting mobility management (MM) protocols for IP and non-IP traffic/services provided by the SGSN 105.

FIG. 2A shows how dual tunnels are established in the conventional wireless communication system 100 of FIG. 1 to provide IP connectivity for user plane traffic. As shown in FIG. 2A, a GPRS tunnelling protocol (GTP) user plane (GTP-U) tunnel 220 is established between a GGSN 205 and an SGSN 210, and a second user plane tunnel 225 is established between the SGSN 210 and a radio network controller (RNC) 215. Both tunnels are dedicated to the same user. The GTP tunnel 220 has a user plane and a control plane. The user tunnel 225 is an IP tunnel having a user plane and a RAN application part (RANAP) control plane used for control messaging.

FIG. 3 shows the system architecture evolution (SAE) of a long term evolution (LTE)-based network with various interfaces/protocols as well as user data transfer interfaces between various network entities. The wireless communication system 300 includes an evolved packet core 305 comprising at least one mobility management entity (MME)/user plane entity (UPE) 310 and at least one inter-access system (AS) anchor 315, also called an access gateway (AGW). An evolved radio access network 320 includes at least one evolved Node-B (eNodeB). The wireless communication system 300 further comprises a GPRS core 325 as described above with reference to FIG. 1, which includes at least one universal terrestrial radio access network (UTRAN) 330, and at least one GPRS enhanced data rates for global system for mobile communications (GSM) evolution (EDGE) radio access network (GERAN) 335. Mobility of WTRUs (not shown) in the wireless communication system 300 is facilitated by anchoring Internet Protocol (IP) sessions at the AGW 315 and allowing for multi-level mobility by supporting MM protocols for IP traffic/services provided by the AGW 315.

LTE based networks are the evolution toward all IP Networks (AIPNs). IP traffic generated from the network operator, such as instant messaging, and non third generation partnership project (3GPP) IP traffic, (i.e., wireless local area network (WLAN) traffic), is anchored and routed through the AGW 315.

One objective in LTE is to facilitate mobility and reducing development cost by anchoring IP sessions at the AGW and allowing for multi-level mobility and supporting existing GPRS/3G MM protocols. In LTE, most of the services and applications are migrating toward IP-based platforms. This migration requires IP connectivity and the traffic generated does not have be terminated at a mobility management entity (MME)/user plane entity (UPE), as it is the case in GPRS.

The current packet data protocol (PDP) context activation performed in GPRS and universal mobile telecommunications system (UMTS) 3GPP systems is dedicated to single bearer services.

Primary PDP context activation performs IP configuration and the selection of access point name (APN) associated with session initiation protocol (SIP) signaling. A secondary PDP context activation is needed for each additional bearer service. This means that the three-way handshake process will be repeated over and over for each additional service to be activated, (e.g., email, streaming, web browsing, and the like). There is a need to simplify this method by reducing the number of PDP (primary and secondary) activations signaled and increase the setup time to perform any of the above mentioned services.

### SUMMARY

The present invention is related to a method of activating multiple bearer services in an LTE wireless communication system including multiple bearers. At least one of the multiple bearers is activated during the initial attach procedures combining the attach procedure with activate PDP context activation procedures. In one embodiment, LTE attach procedures are implemented for multi-bearer services activation that establishes an LTE direct GTP tunnel or normal GPRS GTP two-tunnels operation. In another embodiment, the initial attach procedures are used to activate a default PDP context to be followed by modified PDP context activation procedures for multi-bearer services activation. These procedures can be used to establish a modified LTE direct GTP tunnel or a normal GTP two-tunnels operation.

The present invention changes existing GPRS procedures by performing a single step of activation of multiple bearers during the initial attached procedures, or using the initial attached procedures to activate a default bearer, followed by modify procedures that activate the remaining multiple bearers in a single step.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional GPRS/3G wireless communication system architecture;

FIG. 2A shows establishment of a conventional GTP user plane tunnel;

FIG. 2B shows establishment of a single GTP tunnel in accordance with the present invention;

FIG. 3 shows the system architecture evolution (SAE) of an LTE-based wireless communication system;

FIG. 4 shows a conventional tunnel protocol stack;

FIG. 5 shows an LTE GTP protocol stack in accordance with the present invention;

FIG. 6 is a signal flow diagram of a conventional tunnel establishment procedure;

FIG. 7 is a signal flow diagram of LTE attach procedures for a multi-bearer services activation for establishing an LTE single GTP tunnel; and

FIG. 8 is a signal flow diagram of modified PDP context activation procedures for multi-bearer services activation for establishing an LTE single GTP tunnel.

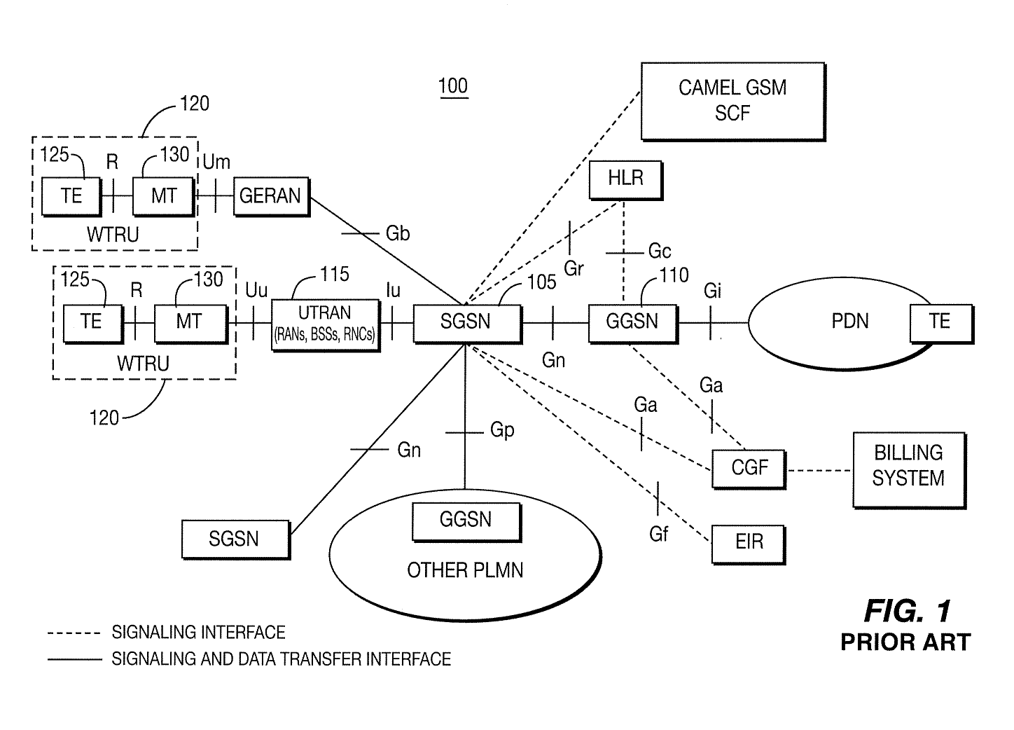

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to an eNodeB, a site controller, an access point (AP), or any other type of interfacing device capable of operating in a wireless environment.

The features of the present invention may be incorporated into an integrated circuit (IC) or be configured in a circuit comprising a multitude of interconnecting components.

In accordance with the present invention, the mobility in GPRS, (3G or beyond), systems is facilitated by anchoring the IP session at the home GGSN and allowing for multi-level mobility, and by supporting existing MM protocols for non-IP traffic/services provided by the SGSN.

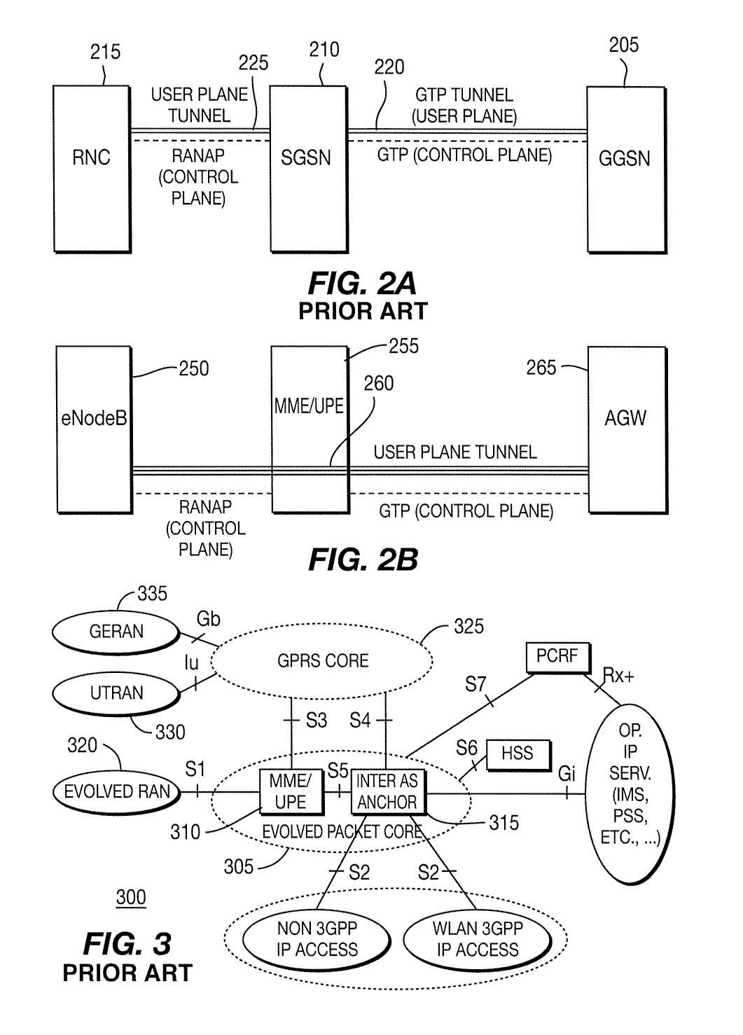

FIG. 2B shows a single user-plane tunnel approach in accordance with the present invention. A single user plane tunnel 260 is used to reduce the delay and processing power of an MME/UPE 255. In the two-tunnel approach shown in FIG. 2A, the SGSN 210 terminates both the GTP tunnel 220 and a user plane tunnel 225 to the RNC 215, which means that the SGSN 210 decodes the packets traveling in both directions and translates them into the different protocol formats of the two tunnels 220 and 225. In a single tunnel approach shown in FIG. 2B, the MME/UPE 255 only establishes a tunnel between the AGW 265 and the eNodeB 250 via two separate interfaces/protocols, (RANAP-C and GTP-C). In the single tunnel approach, the MME/UPE 255 is not involved in the user plane traffic. Thus, the user traffic passes through the MME/UPE 255 unchanged, (i.e., unaltered), in both directions. Only the eNodeB 250 and the AGW 265 are allowed to perform/act on the user plane traffic. The MME/UPE 255 only manages the control traffic, including MM, routing area update (RAU), and the like, associated with the user and its IP based traffic. The MME/UPE 255 connects an eNodeB 250 and an AGW 265 using a GTP control plane to communicate with the AGW 265 and a RANAP control plane to communicate with the eNodeB 250. When a handoff occurs between eNodeBs, the MME/UPE 255 is responsible for providing the AGW 265 with the new eNodeB tunnel endpoint identity (TEID) information and the establishment of the single tunnel 260.

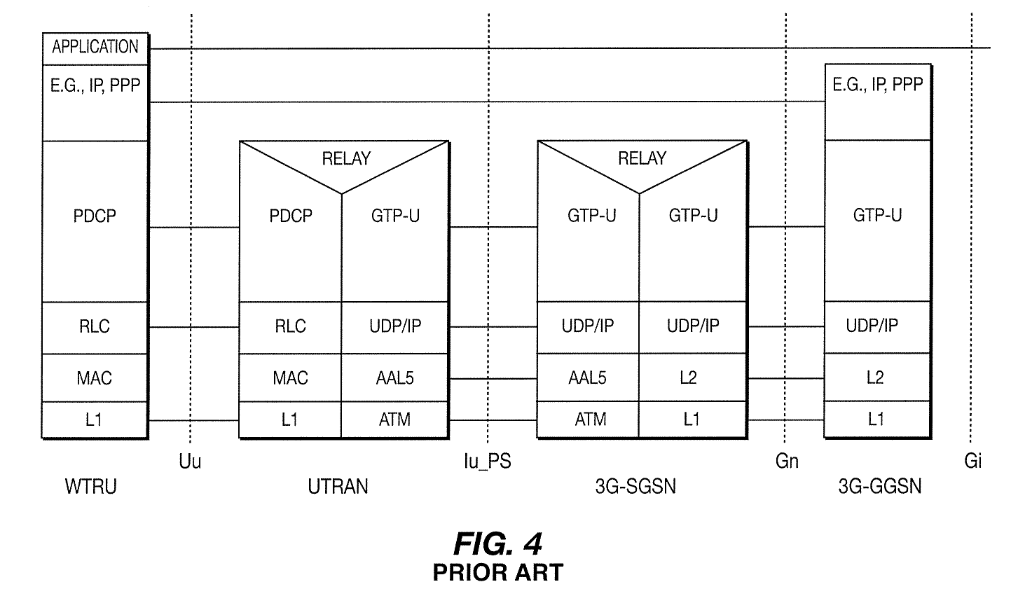

FIG. 4 shows a prior art tunnel protocol stack according to existing GPRS protocol. A GTP-U tunnel transfers, (i.e., tunnels), user data between a UTRAN (which includes RANs, BSSs and RNCs) and a 3G-SGSN, and between the 3G-SGSN and a 3G-GGSN.

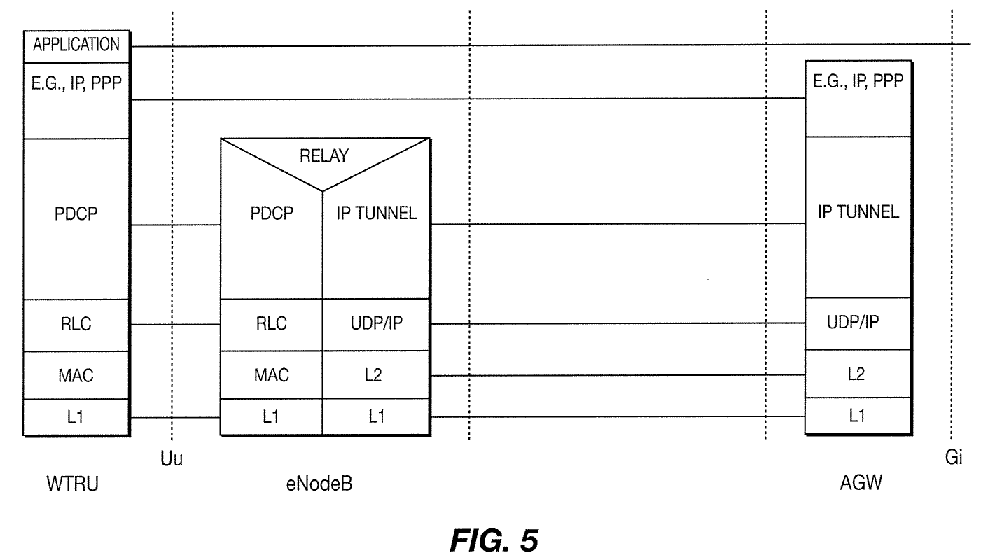

FIG. 5 shows tunnel protocol stack in accordance with the present invention, in which the user plane tunnel is established between an eNodeB and an AGW. The IP Tunnel shown in FIG. 5 can be GTP-based or any generic IP-Tunnel. In a preferred embodiment, the GTP-U tunnel is used as an IP tunnel.

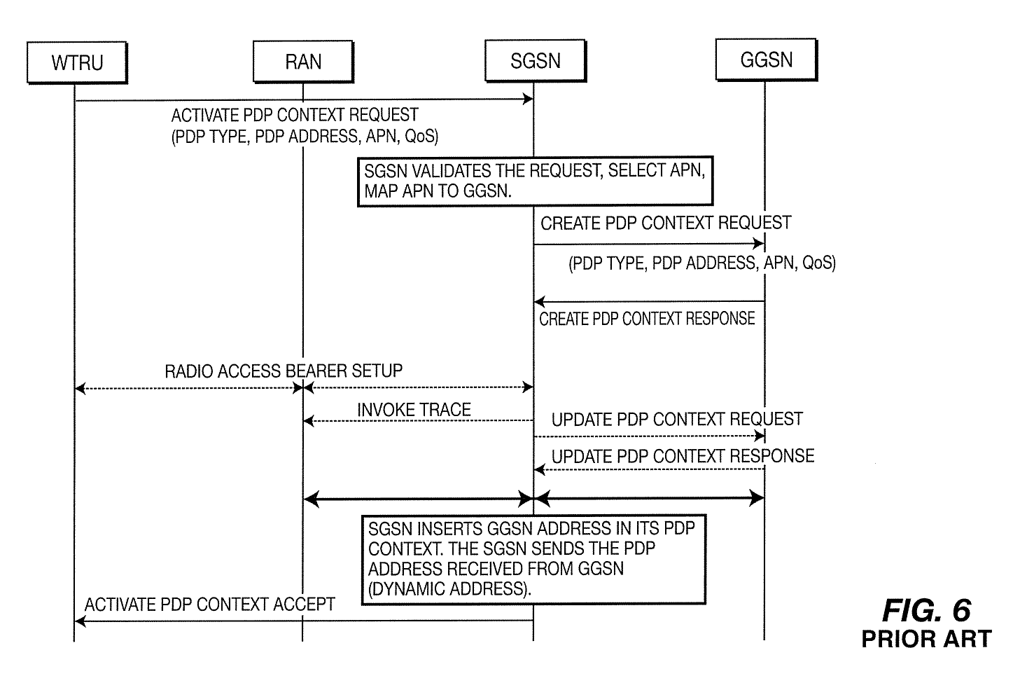

FIG. 6 is a conventional signaling diagram of a process for single tunnel establishment. The single tunnel functionality reduces the delay and processing power at the SGSN by reducing the need for protocol translation between the RNC and GGSN interfaces, and by enabling direct user plane tunnel between the RAN/RNC and the GGSN within the packet switched (PS) domain. However, the single tunnel approach will not eliminate the need for the SGSN to manage control traffic for IP-based traffic. The SGSN is still needed for the control plane signalling, MM and call/session management, and the SGSN makes a decision as to whether to establish a single tunnel or establish dual tunnels.

In the case of a single tunnel, the SGSN should connect the RAN/RNC TEID and the GGSN TEID for user plane by informing each end point of the tunnel of the corresponding TEID of the other end point, (i.e., informing the GGSN of the RNC TEID and informing the RNC of the GGSN TEID). In the case of a handoff between RNCs, the SGSN is responsible for updating and providing the GGSN with new RNC TEID information and the establishment of the single tunnel.

In a preferred embodiment of the invention, the activation of multiple bearers for multiple services during the primary PDP context activation are performed while the WTRU initiates packet switched (PS)-attach procedures. The WTRU preferably includes a list of services that need to be activated and the associated network service access point identifier (NSAPI) in the attach request.

The SGSN then preferably selects the APN, (e.g., a GGSN or an AGW) that performs these services. In the preferred embodiment, an MME/UPE is used as the SGSN. The SGSN (MME/UPE) preferably establishes the multi bearers in the radio network controller (RNC)/eNodeB. The RNC/eNodeB preferably establishes the multi-bearers with the WTRU and confirms back to the SGSN. The SGSN (MME/UPE) preferably establishes the tunneling required between the GGSN/AGW and the RNC/eNodeB whether it is a single tunnel (LTE/single tunnel GPRS) or two tunnels (GPRS). The SGSN then preferably allocates the IP and confirms the allocation of bearers and their associated NSAPI.

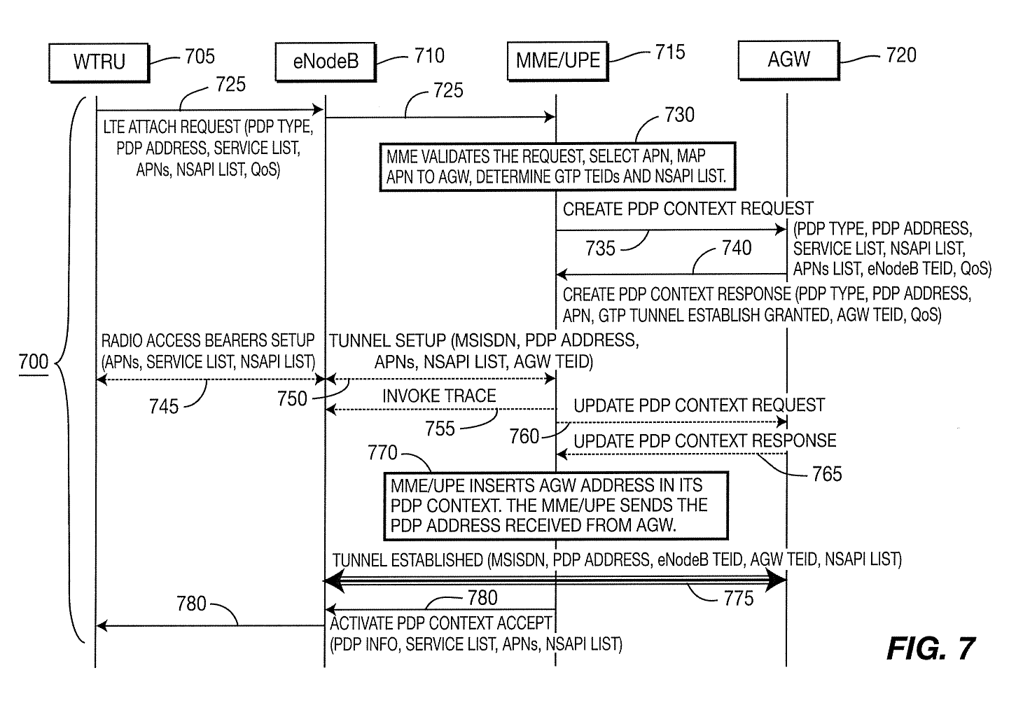

FIG. 7 shows an LTE single GTP tunnel establishment (LTE attach) procedure 700 for activating multi-bearer services, which is implemented in a wireless communication system including a WTRU 705, an eNodeB 710, an MME/UPE 715 and an AGW 720 in accordance with a first embodiment of the present invention. The WTRU 705 sends an LTE attach request message to the eNodeB 710 and the MME/UPE 715 that includes one or more information elements (IEs) (step 725). The IEs may include one or more of the following: PDP type, PDP address, service list, APNs, a NSAPI list and quality of service (QoS) associated with each service. The NSAPI list is used to map specific services to specific end points at the WTRU 705 and the Core Network. The MME of the MME/UPE 715 validates the LTE attach request, selects an APN, maps the selected APN to the AGW 720 and determines the GTP TEIDs and the NAPSI list (step 730). The MME of the MME/UPE 715 forwards the NSAPI list to the AGW 720 to identify the user service end points. The MME of the MME/UPE 715 validates the service list against the subscriber profile in the home subscriber server (HSS). The selection of APN is based on many variables including the service identification. The MME/UPE 715 determines if a single tunnel is supported and/or requested, and notes the existence of the GTP TEIDs and NSAPI list (step 730). The admission control point where the MME performs service validation against the user profile selects the appropriate APN for each service. The MME then contacts the gateway(s) to establish the PD context for each service identified in the list and according to the respective QoS profile.

The MME/UPE 715 creates a PDP context request that includes information regarding at least one of the following: PDP Type, PDP Address, service list, NSAPI list, APNs list, eNodeB TEID and QoS (step 735). The AGW 720 creates a PDP context response that preferably includes information regarding at least one of the following: PDP Type, PDP Address, APN, an indicator that the establishment of the GTP tunnel is granted, AGW TEID and QoS (step 740). The WTRU 705 and the eNodeB 710 setup a plurality of radio access bearers (RABs) that include APNs, a service list and a NSAPI list (step 745). In this step, the eNodeB 810 establishes a radio bearer for each service and uses the NSAPI list to mark each service. In step 750, the MME/UPE 715 and the eNodeB 710 exchange tunnel setup signaling that includes a mobile station international subscriber directory number (MSISDN), a PDP address, APNs, a NSAPI list and an AGW TEID, and the MME/UPE 715 sends tunnel establishment information to the eNodeB 710 after receiving an indication of acceptance from the AGW 720 to establish the tunnel. In step 755, the MME/UPE 715 sends an invoke trace message to the eNodeB 710. The MME/UPE 715 sends an update PDP context request to the AGW 720 (step 760) to establish the new tunnel by informing the AGW 720 of the AGW TEID associated with the request, and the AGW 720 sends an update PDP context response to the MME/UPE 715 (step 765) confirming or rejecting the establishment of the tunnel and the associated attributes, (RNC TEID, PDP type, PDP address, user ID, and the like). The MME/UPE 715 inserts the AGW address in its PDP context, sends the PDP address received from the AGW 720 (step 770) and prepares for the response to be sent down to the WTRU 705. Thus, if necessary, the MME/UPE 715 updates the PDP context in the AGW 720 to reflect any changes in the QoS attributes resulting from the RAB setup of step 745. Tunnel establishing signaling is exchanged between the eNodeB 710 and the AGW 720 including the MSISDN, PDP address, eNodeB TEID, AGW TEID and NSAPI list (step 775. The MME/UPE 715 sends an activate PDP context accept signal to the WTRU 705 that indicates the presence of a single tunnel (step 780). The activate PDP context accept signal preferably includes PDF information, a service list, APNs and a NSAPI list. The PDP information includes the IP address and IP version, (e.g., v4 or v6).

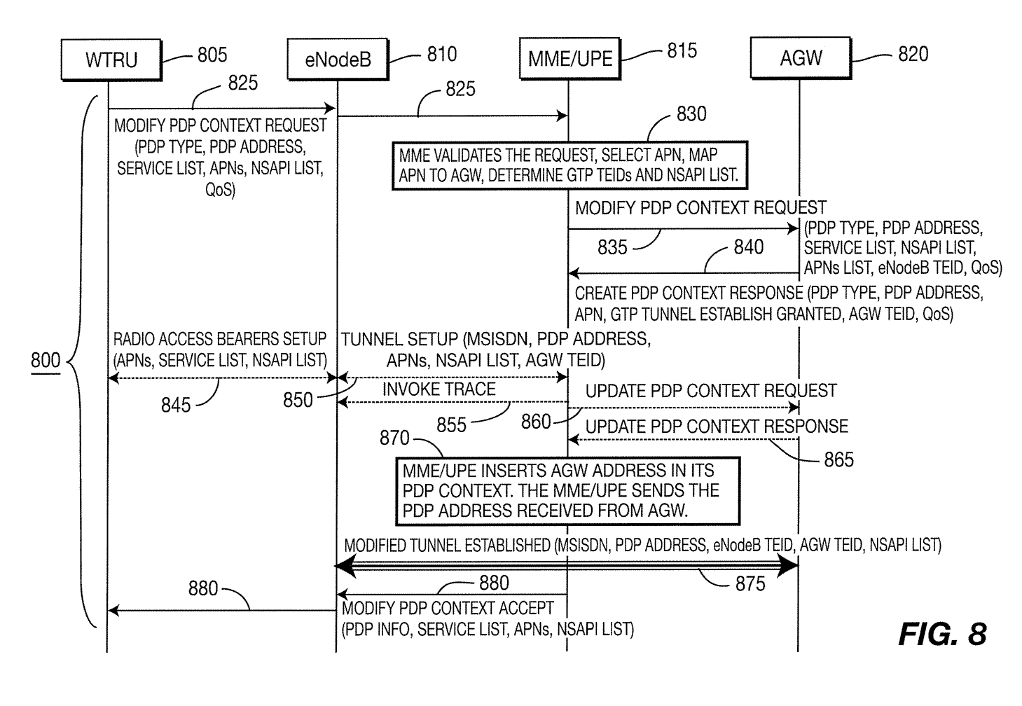

FIG. 8 shows an LTE single GTP tunnel establishment (PDF context modification) procedure 800 for activating multi-bearer services, which is implemented in a wireless communication system including a WTRU 805, an eNodeB 810, an MME/UPE 815 and an AGW 820 in accordance with a second embodiment of the present invention. The WTRU 805 sends an modify PDF context request message to the eNodeB 810 and the MME/UPE 815 that includes one or more IEs (step 825). The IEs may include one or more of the following: PDP type, PDP address, service list, APNs, a NSAPI list and QoS associated with each service (step 825). The NAPSI list is used to map specific services to specific end points at the WTRU 805 and the Core Network. The MME of the MME/UPE 815 validates the modify PDP context request, selects an APN, maps the selected APN to the AGW 820 and determines the GTP TEIDs and the NAPSI list (step 830). The MME of the MME/UPE 815 determines if a single tunnel is supported and/or requested, and notes the existence of the GTP TEIDs and NSAPI list (step 830).

The MME/UPE 815 creates a modify PDP context request that includes information regarding at least one of the following: PDP Type, PDP Address, service list, NSAPI list, APNs list, eNodeB TEID and QoS (step 835). The AGW 820 creates a PDP context response that preferably includes information regarding at least one of the following: PDP Type, PDP Address, APN, an indicator that the establishment of the GTP tunnel is granted, AGW TEID and QoS (step 840). The WTRU 805 and the eNodeB 810 setup a plurality of RABs that include APNs, a service list and a NSAPI list (step 845). In step 850, the MME/UPE 815 and the eNodeB 810 exchange tunnel setup signaling that includes a mobile station international subscriber directory number (MSISDN), a PDP address, APNs, a NSAPI list and an AGW TEID, and the MME/UPE 815 sends tunnel establishment information to the eNodeB 810 after receiving an indication of acceptance from the AGW 820 to establish the tunnel. In step 855, the MME/UPE 815 sends an invoke trace message to the eNodeB 810. The MME/UPE 815 sends an update PDP context request to the AGW 820 (step 860) to establish the new tunnel by informing the AGW 820 of the AGW TEID associated with the request, and the AGW 820 sends an update PDP context response to the MME/UPE 815 (step 865) confirming or rejecting the establishment of the tunnel and the associated attributes, (RNC TEID, PDP type, PDP address, user ID, and the like). The MME/UPE 815 inserts the AGW address in its PDP context, sends the PDP address received from the AGW 820 (step 870) and prepares for the response to be sent down to the WTRU 805. Thus, if necessary, the MME/UPE 815 updates the PDP context in the AGW 820 to reflect any changes in the QoS attributes resulting from the RAB setup of step 845. A modified tunnel establishing signaling is exchanged between the eNodeB 810 and the AGW 820 including the MSISDN, PDP address, eNodeB TEID, AGW TEID and NSAPI list (step 875). The MME/UPE 815 sends a modify PDP context accept signal to the WTRU 805 that indicates the presence of a single modified tunnel (step 880). The activate PDP context accept signal preferably includes PDF information, a service list, APNs and a NSAPI list.

The above preferred methods are preferably implemented, by way of example, as software or middleware, at the WTRU and the eNodeB or similar base station. The implementation is applicable to various communication layers, including by not limited to the network layer, the session layer and the presentation layer.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of establishing a direct tunnel for a wireless transmit/receive unit (WTRU) in a wireless communication system including an evolved Node-B (eNodeB), a mobility management entity (MME) and at least one access gateway (AGW), the method comprising:
(a) the WTRU sending a long term evolution (LTE) attach request message to the MME via the eNodeB, the LTE attach request message including a list of services requiring activation, a list of network service access point identifiers (NSAPIs) and quality of service (QoS) profiles associated with the list of services;
(b) establishing a packet data protocol (PDP) context between the eNodeB and the AGW for each service identified by the list of services; and
(c) establishing a radio access bearer between the WTRU and the eNodeB for each service identified by the list of services using the associated NSAPIs.

2. The method of claim 1 further comprising:
(d) the MME establishing tunneling required between the AGW and the eNodeB; and
(e) the MME confirming the allocation of bearers and their associated NSAPIs.

3. The method of claim 2 wherein the NAPSI list is used to map specific services to specific end points at the WTRU.

4. The method of claim 2 further comprising:
the MME forwarding the NSAPI list to the AGW to identify the user service end points.

5. The method of claim 2 further comprising:
the MME validating the service list against a subscriber profile in a home subscriber server (HSS) and authorizing the resources required to support the services required.

6. A method of activating multiple bearer services in a wireless communication system including a wireless transmit/receive unit (WTRU), an evolved Node-B (eNodeB), a mobility management entity (MME) and at least one access gateway (AGW), wherein a single default packet data protocol (PDP) context is established between the eNodeB and the AGW, the method comprising:
(a) the WTRU sending a modify PDP context request message to the MME via the eNodeB, the modify PDP context request message including a list of services requiring activation and a list of network service access point identifiers (NSAPIs);
(b) establishing an additional PDP context between the eNodeB and the AGW for each service identified by the list of services; and
(c) establishing a plurality of radio access bearers between the WTRU and the eNodeB for each service identified by the list of services using the associated NSAPIs.

7. The method of claim 6 further comprising:
(d) the MME modifying tunneling established between the AGW and the eNodeB; and
(e) the MME confirming the allocation of bearers and their associated NSAPIs.

8. The method of claim 7 wherein the NAPSI list is used to map specific services to specific end points at the WTRU.

9. The method of claim 7 further comprising:
the MME forwarding the NSAPI list to the AGW to identify the user service end points.

10. The method of claim 7 further comprising:
the MME validating the service list against a subscriber profile in a home subscriber server (HSS) and authorizing the resources required to support the services required.

11. In a long term evolution (LTE) wireless communication system using multiple radio bearers, a method of activating multiple bearer services, the method comprising:
activating a plurality of the multiple bearers during a primary packet data protocol (PDP) context activation, wherein the PDP context activation is performed while packet switched (PS) attach procedures are initiated.

12. A wireless communication system comprising:
a mobility management entity (MME);
an evolved Node-B (eNodeB);
at least one access gateway (AGW); and
a wireless transmit/receive unit (WTRU) configured to send a long term evolution (LTE) attach request message to the MME via the eNodeB, the LTE attach request message including a list of services requiring activation, a list of network service access point identifiers (NSAPIs) and quality of service (QoS) profiles associated with the list of services, establish a packet data protocol (PDP) context between the eNodeB and the AGW for each service identified by the list of services, and establish a plurality of radio access bearers between the WTRU and the eNodeB for each service identified by the list of services using the associated NSAPIs.

13. The system of claim 12 wherein the MME is configured to establish tunneling required between the AGW and the eNodeB, and confirm the allocation of bearers and their associated NSAPIs.

14. The system of claim 13 wherein the NAPSI list is used to map specific services to specific end points at the WTRU.

15. The system of claim 13 wherein the MME is further configured to forward the NSAPI list to the AGW to identify the user service end points.

16. The system of claim 13 wherein the MME is further configured to validate the service list against a subscriber profile in a home subscriber server (HSS) and authorize the resources required to support the services required.

17. A wireless communication system comprising:
a mobility management entity (MME);
an evolved Node-B (eNodeB);
an access gateway (AGW), wherein a single default packet data protocol (PDP) context is established between the eNodeB and the AGW; and
a wireless transmit/receive unit (WTRU) configured to send a modify packet data protocol (PDP) context request message to the MME via the eNodeB, the modify PDP context request message including a list of services requiring activation and a list of network service access point identifiers (NSAPIs), establish an additional PDP context between the eNodeB and the AGW for each service identified by the list of services, and establish a plurality of radio access bearers between the WTRU and the eNodeB for each service identified by the list of services using the associated NSAPIs.

18. The system of claim 17 wherein the MME is configured to modify tunneling established between the AGW and the eNodeB, and confirm the allocation of bearers and their associated NSAPIs.

19. The system of claim 18 wherein the NAPSI list is used to map specific services to specific end points at the WTRU.

20. The system of claim 18 wherein the MME is further configured to forward the NSAPI list to the AGW to identify the user service end points.

21. The system of claim 18 wherein the MME is further configured to validate the service list against a subscriber profile in a home subscriber server (HSS) and authorize the resources required to support the services required.

22. A method of establishing a direct tunnel for a wireless transmit/receive unit (WTRU) in a wireless communication system including a radio access network (RAN), a serving general packet radio service (GPRS) support node (SGSN) and at least one gateway GPRS support node (GGSN), the method comprising:
(a) the WTRU sending an attach request message to the SGSN via the RAN, the attach request message including a list of services requiring activation, a list of network service access point identifiers (NSAPIs) and quality of service (QoS) profiles associated with the list of services;
(b) establishing a packet data protocol (PDP) context between the RAN and the GGSN for each service identified by the list of services; and
(c) establishing a radio access bearer between the WTRU and the RAN for each service identified by the list of services using the associated NSAPIs.

23. The method of claim 22 further comprising:
(d) the SGSN establishing tunneling required between the GGSN and the RAN; and
(e) the SGSN confirming the allocation of bearers and their associated NSAPIs.

24. The method of claim 22 wherein the NAPSI list is used to map specific services to specific end points at the WTRU.

25. The method of claim 22 further comprising:
the SGSN forwarding the NSAPI list to the GGSN to identify the user service end points.

26. The method of claim 22 further comprising:
the SGSN validating the service list against a subscriber profile in a home subscriber server (HSS) and authorizing the resources required to support the services required.

27. A method of activating multiple bearer services in a wireless communication system including a wireless transmit/receive unit (WTRU), a radio access network (RAN), a serving general packet radio service (GPRS) support node (SGSN) and at least one gateway GPRS support node (GGSN), wherein a single default packet data protocol (PDP) context is established between the RAN and the GGSN, the method comprising:
(a) the WTRU sending a modify PDP context request message to the SGSN via the RAN, the modify PDP context request message including a list of services requiring activation and a list of network service access point identifiers (NSAPIs);
(b) establishing an additional PDP context between the RAN and the GGSN for each service identified by the list of services; and
(c) establishing a plurality of radio access bearers between the WTRU and the RAN for each service identified by the list of services using the associated NSAPIs.

28. The method of claim 27 further comprising:
(d) the SGSN modifying tunneling established between the GGSN and the RAN; and
(e) the SGSN confirming the allocation of bearers and their associated NSAPIs.

29. The method of claim 27 wherein the NAPSI list is used to map specific services to specific end points at the WTRU.

30. The method of claim 27 further comprising:
the SGSN forwarding the NSAPI list to the GGSN to identify the user service end points.

31. The method of claim 27 further comprising:
the SGSN validating the service list against a subscriber profile in a home subscriber server (HSS) and authorizing the resources required to support the services required.

32. A method of establishing a dual-tunnel for a wireless transmit/receive unit (WTRU) in a wireless communication system including a radio access network (RAN), a serving general packet radio service (GPRS) support node (SGSN) and at least one gateway GPRS support node (GGSN), the method comprising:
(a) the WTRU sending an attach request message to the SGSN via the RAN, the attach request message including a list of services requiring activation, a list of network service access point identifiers (NSAPIs) and quality of service (QoS) profiles associated with the list of services;
(b) establishing a packet data protocol (PDP) context between the SGSN and the GGSN for each service identified by the list of services;
(c) establishing a packet data tunnel between the SGSN and the RAN for each service identified by the list of services; and
(d) establishing a radio access bearer between the WTRU and the RAN for each service identified by the list of services using the associated NSAPIs.

33. The method of claim 32 further comprising:
(e) the SGSN establishing general packet radio service (GPRS) tunneling protocol (GTP) tunneling required between the GGSN and the SGSN;
(f) the SGSN establishing tunneling required between the RAN and the SGSN; and
(g) the SGSN confirming the allocation of bearers and their associated NSAPIs.

34. A method of activating multiple bearer services in a wireless communication system including a wireless transmit/receive unit (WTRU), a radio access network (RAN), a serving general packet radio service (GPRS) support node (SGSN) and at least one gateway GPRS support node (GGSN), wherein a single default packet data protocol (PDP) context is established through an attach procedure between the SGSN and the GGSN, the method comprising:
(a) the WTRU sending a modify PDP context request message to the SGSN via the RAN, the modify PDP context request message including a list of services requiring activation and a list of network service access point identifiers (NSAPIs);
(b) establishing an additional PDP context between the SGSN and the GGSN for each service identified by the list of services;
(c) establishing an additional tunnel between the RAN and the SGSN for each service identified by the list of services; and
(d) establishing a plurality of radio access bearers between the WTRU and the RAN for each service identified by the list of services using the associated NSAPIs.

35. The method of claim 34 further comprising:
(e) the SGSN establishing tunneling required between the GGSN and the SGSN;
(f) the SGSN establishing tunneling required between the RAN and the SGSN; and
(g) the SGSN confirming the allocation of bearers and their associated NSAPIs.
